(19) United States
(12) Patent Application Publication
(10) Pub. No.: US 2026/0169799 A1
(43) Pub. Date: Jun. 18, 2026

(54) OPTIMIZING RESOURCE UTILIZATION FOR STATEFULSETS

(71) Applicant: SAP SE, Walldorf (DE)

(72) Inventor: Anantharaman Kalyanakrishnan, Union City, CA (US)

(21) Appl. No.: 18/978,814

(22) Filed: Dec. 12, 2024

(51) Int. Cl. G06F 9/50

(52) U.S. Cl. CPC G06F 9/5016

(57) ABSTRACT

In an example embodiment, resource utilization and resource assignment among StatefulSet instances is monitored and usage metrics are maintained. Multiple different StatefulSets are established, with each set having a different level of resource allocation. Individual instances can then be dynamically assigned/reassigned to the different StatefulSets based on resource utilization. An auto-scaler is provided to scale each StatefulSet to the needed number of instances.

### TECHNICAL FIELD

This document generally relates to container-orchestration systems. More specifically, this document relates to optimizing resource utilization for managing stateless applications in a container-orchestration system

### BACKGROUND

Container-orchestration systems, such as Kubernetes can be used to deploy, scale, and manage computer applications. In a container-orchestration system, an operator is a software component that handles lifecycle event of stateful applications. A control loop watches particular resources and reacts on state changes of these resources. In a Platform-as-a-Service offering, services, such as database services, may be defined as particular resources with subresources containers, configurations, secrets). An operator watches for the particular service resource and, in the case of a create/update/delete event, takes the appropriate actions, such as creating, updating, or deleting subresources.

### BRIEF DESCRIPTION OF DRAWINGS

The present disclosure is illustrated by way of example and not limitation in the figures of the accompanying drawings, in which like references indicate similar elements.

FIG. 1 is a network diagram illustrating a network environment suitable for using Kubernetes as a distributed operating system for a scalable application system, according to some example embodiments.

FIG. 2 is a block diagram illustrating components of the Kubernetes cluster, according to some example embodiments.

FIG. 3 is a block diagram illustrating a system for dynamically assigning resources to instances, in accordance with an example embodiment.

FIG. 4 is a flow diagram illustrating a method for assigning instances in a container-orchestration system, in accordance with an example embodiment.

FIG. 5 is a flow diagram illustrating a method for clearing a metrics cache, in accordance with an example embodiment.

FIG. 6 is a flow diagram illustrating a method for metrics cache handling and recovery, in accordance with an example embodiment.

FIG. 7 is a block diagram illustrating an architecture of software, which can be installed on any one or more of the devices described above.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

StatefulSets are a Kubernetes resource designed to manage stateful applications. Unlike Deployments, which are typically used for stateless applications, StatefulSets provide unique identities and stable storage for each pod in a set. This makes them ideal for applications that require persistent storage and need to maintain their state, such as databases.

Each pod within a StatefulSet is allocated the same amount of resources. Thus, for example, in the case where a StatefulSet is used to manage the delivery of events from an event producer to an event consumer, such as via a Kafka message broker, each different consumer can be assigned to a different pod within a StatefulSet. Using StatefulSets in this way allows for the consumers to be each assigned a unique, stable, network identity that persists across rescheduling, stable persistent storage to ensure data continuity even if the corresponding pod is deleted and recreated, and allows instance-specific processes, determined by metadata maintained by application teams, to be assigned to the different pods. In such a case, however, due to how StatefulSets are defined, each pod gets assigned the same resources, such as memory resources (storage space) and/or processing resources (e.g., central processing unit (CPU) utilization).

This creates a technical problem when operating in systems where the resource utilization is varied. For example, one event consumer may utilize only 100 MB of storage space while another will utilize 1 GB. In such a case, it is necessary to define each pod as providing at least 1 GB of space (likely more, though, to account for potential occasional overages). This wastes resources on pods that are not going to utilize those resources. Additionally, the usage by event consumers may change over time. A particular event consumer may only be utilizing 100 MB of storage space now but may eventually require 2 GB of space. There currently is no mechanism to easily reassign instances in a StatefulSet more resources. What typically happens is that the StatefulSet is deleted and recreated with a higher resource allocation for each pod.

In an example embodiment, resource utilization and resource assignment among StatefulSet instances is monitored and usage metrics are maintained. Multiple different StatefulSets are established, with each set having a different level of resource allocation. Individual instances can then be dynamically assigned/reassigned to the different StatefulSets based on resource utilization. An auto-scaler is provided to scale each StatefulSet to the needed number of instances.

Kubernetes is a system for automating deployment, scaling, and management of containerized applications. Application containerization is a virtualization method used by operating systems to deploy and run distributed applications without launching an entire virtual machine for each application.

A container is a lightweight, portable, and self-sufficient software unit that includes everything needed to run the application: code, libraries, dependencies, system tools, and settings. Containers isolate the application from the underlying infrastructure, making them consistent and easy to deploy across various environments, such as development, testing, and production.

Containerized applications have advantages over standard applications. When a standard application is installed on a server, libraries required by the application are also installed. Thus, if multiple applications are installed, the libraries on the server are an amalgamation of the libraries required by each of the multiple applications. If one application installs a different version of a library used by another application, the first installed version is overwritten. As a result, an application may use a version of a library that was not tested with the application, which may further result in unexpected behavior.

Kubernetes containers, by virtue of being so modular, are quite conducive to scaling of in-memory database instances, as well as other types of software components, such as applications, application program interface (API) servers, etc.. Kubernetes containers may be contained in pods. Each pod is scheduled on a specific host and encapsulates a container for each of one or more applications. This is typically based on a configuration. Without a configuration, an instance can be assigned to any available host and automatically gets assigned to the next available host if there are availability issues. Thus, if the host becomes unavailable, Kubernetes automatically instantiates the instance on a different host, greatly easing maintenance. Pods scale based on a range of factors defined in another Kubernetes artifact, but this scalability is what is missing for stateful sets.

A stateful service is one in which state data are persisted. An in-memory or traditional database may be used to persist the state for these stateful services, but they can be managed in Kubernetes clusters using an application program interface (API) extension of a custom resource definition (CRD). A CRD is a set of parameters used by Kubernetes in managing the lifecycle of Kubernetes objects, such as pods. In an example embodiment, stateful applications managed by Kubernetes custom resources are utilized with the behavior toggles. That is, the lifecycle of the stateful application is managed by a custom resource and its controller. This concept is known as a Kubernetes operator.

Lifecycle of the application would include provisioning and decommissioning application instances, as well as any configuration changes of the applications other than actually using the application.

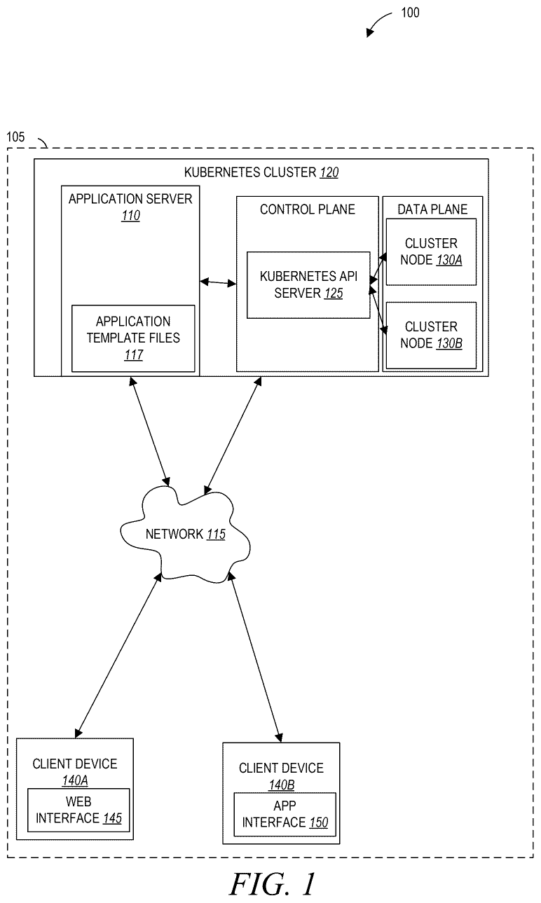

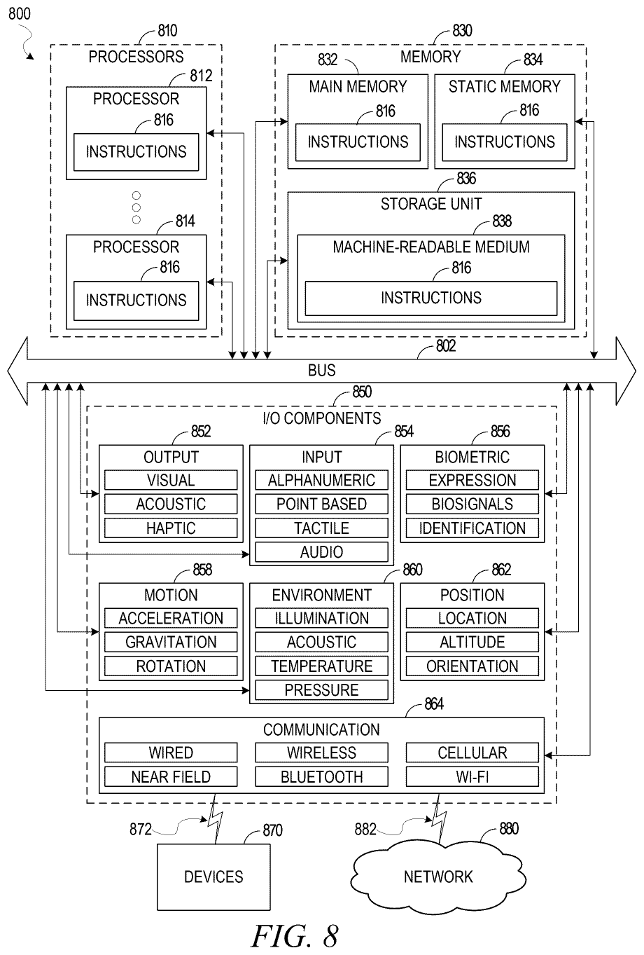

FIG. 1 is a network diagram illustrating a network environment 100 suitable for using Kubernetes as a distributed operating system for a scalable application system, according to some example embodiments. The network environment 100 includes a network-based application 105, which includes client devices 140A and 140B, and a network 115. The network-based application 105 is provided by an application server 110 in communication with a Kubernetes cluster 120. The application server 110 accesses application template files 117 to configure and deploy an application to the Kubernetes cluster 120 via the Kubernetes API server 125 interacting with a set of cluster nodes 130A, 130B. The containerized application is provided to the client devices 140A and 140B via a web interface 145 or an application interface 150. The application server 110, the Kubernetes API server 125, the cluster nodes 130A and 130B, and the client devices 140A and 140B may each be implemented in a computer system, in whole or in part, as described below with respect to FIG. 8.

The Kubernetes API server 125 provides an interface to the Kubernetes cluster 120 and deploys applications to the cluster nodes 130A and 130B. The selected application may be invoked via a virtual system application. The client devices 140A and 140B may provide identifying information to the application server 110, and the identifying information may be used by the Kubernetes API server 125 or the virtual system application to determine a particular instance of the selected application to invoke.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 110, the Kubernetes API server 125, the cluster nodes 130A-130B, and the client devices 140A-140B may be connected by the network 115. The network 115 may be any network that enables communication between or among machines, databases, and devices. Accordingly, the network 115 may be a wired network, a wireless network (e.g., a mobile or cellular network), or any suitable combination thereof. The network 115 may include one or more portions that constitute a private network, a public network (e.g., the Internet), or any suitable combination thereof.

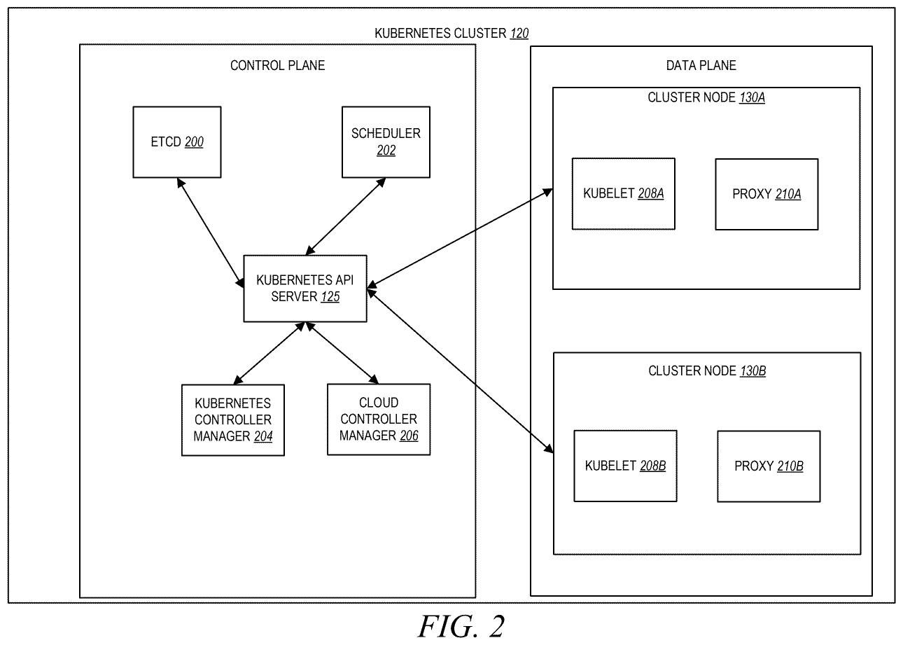

FIG. 2 is a block diagram illustrating components of the Kubernetes cluster 120, according to some example embodiments. The Kubernetes cluster 120 is shown as including the API server 125, as well as an ETCD 200, scheduler 202, Kubernetes controller manager 204, and cloud controller manager 204, all contained in a control plane. ETCS 200 is a consistent and highly-available key value store used as a backing store for all cluster data. Scheduler 202 watches for newly created Pods with no assigned node and selects a node for them to run on (based on, for example, individual and collective resource requirements, hardware/software/policy constraints, affinity and anti-affinity specifications, data locality, inter-workload interference, and deadlines. Controller manager 204 runs controller processes. Logically, each controller is a separate process, but to reduce complexity they all may be compiled into a single binary and run in a single process. Cloud controller manager 206 embeds cloud-specific control logic. It lets a user link a cluster to a cloud provider API, and separates out the components that interact with the cloud platform from components that interact only with the cluster.

A data plane then contains cluster nodes 130A, 130B. Each cluster node 130A, 130B contains a Kubelet 208A, 208B and a proxy 210A, 210B. Kubelet 208A, 208B is an agent that makes sure that containers are running in a Pod. It takes a set of Pod specifications that are provided through various mechanisms and ensures that the containers described in those specifications are running and healthy. The proxy 210A, 210B maintains network rules on a cluster node130A, 103B. These rules allow network communication to Pods from network sessions inside or outside of the Kubernetes cluster 120.

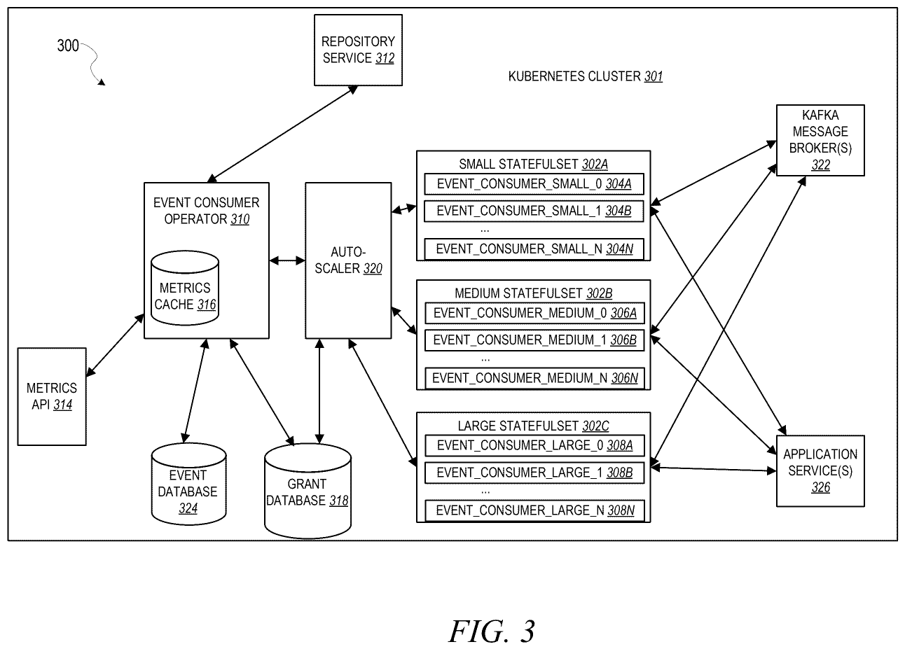

FIG. 3 is a block diagram illustrating a system 300 for dynamically assigning resources to instances, in accordance with an example embodiment. Here, rather than a single StatefulSet being used to manage event consumers, in a Kubernetes cluster 301, three different StatefulSets, specifically Small StatefulSet 302A, Medium StatefulSet 302B, and Large StatefulSet 302C are provided. It should be noted that while exactly three StatefulSets are depicted here, there is no limit on the number of different StatefulSets that can be used to manage the event consumers. For example, rather than a small, medium, and large StatefulSet, the same techniques described herein can be used to establish a small, medium-small, medium, medium-large, and large StatefulSet. Additionally, embodiments are possible where only two StatefulSets are used to manage the event consumers.

The small, medium, and large StatefulSet refers not to the actual size of the StatefulSet itself or the number of instances within the StatefulSet but instead to the amount of resources assigned to instances within the corresponding StatefulSet. Thus, relatively speaking, Small StatefulSet 302A assigns fewer resources (e.g., less memory space, fewer processing threads) to its instances 304A, 304B, . . . , 304N than Medium StatefulSet 302B assigns to its instances 306A, 306B, . . . , 306N. Likewise, Medium StatefulSet 302B assigns fewer resources to its instances 306A, 306B, . . . , 306N than Large StatefulSet 302C assigns to its instances 308A, 308B, . . . , 308N.

An event consumer operator 310 obtains metadata needed to establish the various instances from a repository service 312.

The event consumer operator 310 obtains metrics about resource utilization of the various instances 304A, 304B, . . . , 304N, 306A, 306B, . . . , 306N, 308A, 308B, . . . , 308N from a metrics application program interface (API) 314. In an example embodiment, this may occur every thirty seconds, but this is configurable. The metric information is stored in metrics cache 316. The metric information can be stored by instance, which makes an individual instance's metric information easily cleared from the metrics cache 316 when the time comes. In an example embodiment, the metrics cache 316 holds fifteen minutes worth of data, which is also configurable. This may be held as a rolling window of data, and thus when the cache has fifteen minutes worth of data in it, the next thirty seconds of data added to the metrics cache 316 will knock out the oldest thirty seconds of data.

The event consumer operator 310 then evaluates the metrics data and dynamically determines, based on the metrics data, whether to reassign any particular event consumer to a different StatefulSet. For example, if the resource being monitored is storage space, and the Small StatefulSet 302A is defined as containing instances using less than 500 MB of storage space, the Medium StatefulSet 302B is defined as containing instances using between 500 MB of storage space and 1 GB of storage space, and the Large StatefulSet is defined as containing instances using more than 1 GB of storage space, then if an event consumer associated with the event_consumer_small_1 instance 304B has averaged 700 MB of storage space utilization over the last fifteen minutes, then the event consumer operator 310 may determine that this event consumer should be reassigned from the Small StatefulSet 302A to the Medium StatefulSet 302B.

More specifically, the metadata obtained from the repository service 312 about the various instances is stored in grant database 318. Grant database 318 stores a mapping between the instance names and the corresponding event consumers. Thus, it knows, for example, that event_consumer_small_1 corresponds to the event consumer identified as “eventsubscriber23”. The event consumer operator 310 then knows it needs to cause event_consumer_small_1 to be removed from the Small StatefulSet 302A and have a new event consumer instance corresponding to the “eventsubscriber23” assigned to the Medium StatefulSet 302B.

An auto-scaler 320 can then be used to adjust the assignments in the SatatefulSets based on instructions from the event consumer operator 310. Thus, for example, the auto-scaler 320 would request that the Small StatefulSet 302A reduce its instance count by one and the Medium StatefulSet 302A increase its instance count by one. A new instance could then be added to the Medium StatefulSet 302B corresponding to the “eventsubscriber 23” event consumer.

It should be noted that in some example embodiments it is beneficial to reassign instances to different StatefulSets if their resource utilization is within some threshold of an upper or lower limit of their current StatefulSet. For example, if an instance in the Medium StatefulSet 302B uses storage space that is above 80% of the 1 GB upper bound of the Medium StatefulSet 302B (e.g., greater than 800 MB), then the instance may be reassigned to the Large StatefulSet 302C. Likewise, if an instance in the Medium StatefulSet 302B uses storage space that is less than 80% below the 500 MB lower bound of the Medium StatefulSet 302B (e.g., less than 400 MB), then the instance may be reassigned to the Small StatefulSet 302A.

Furthermore, in an example embodiment, various cache clearing techniques are used to prevent unnecessary reassignments and utilize fresh data. Specifically, the cache entries for a particular instance are cleared if the particular instance is reassigned to a different StatefulSet to avoid reusing previously assigned instance metrics. The cache entries for a particular instance can also be cleared if the instance is deleted or recreated, such as during redeployment or manual pod deletions.

If an instance is “killed” then the cache remains unchanged until and unless the instance is restarted. The event consumer operator 310 watches for such restarts and automatically reassigns the instance to an appropriate size. This helps deal with cases where the instance is killed because it does not have enough resources to perform its functions. For example, if the instance is assigned to the Small StatefulSet 302A but then an operation is requested where the instance suddenly attempts to use 750 MB of space, faster than the metrics can detect this usage increase, then the instance may return an error and be killed. When it is restarted, the 750 MB storage space request will have now been recorded in the metrics cache 316 and thus the restarted instance is assigned to the Medium StatefulSet 302B.

It should be noted that the event consumer operator 310 may, in addition to determining which instances should be assigned to which StatefulSet, also determined the resource allocations for each StatefulSet. This is useful for load balancing as the needs of the system 300 as a whole may change over time. For example, as resource utilization grows and grows, it may turn out that nearly all instances are using more than 2 GB of storage space, thus making the Large StatefulSet 302C have nearly all the assigned instances where the Small StatefulSet 302A and the Medium StatefulSet 302B have barely any instances. In that case, the event consumer operator 310 may redefine the StatefulSets so that the storage space assigned by each StatefulSet is different than before, so that the instances will be more evenly distributed among the StatefulSets. This reconfiguring of the resource allocation levels of the StatefulSets is also important to ensure that instances within a particular StatefulSet do not exceed the StatefulSet's resource allocation. For example, in an example embodiment, if an instance uses more than 2 GB of storage space, then even the 2 GB resource allocation of the Large StatefulSet 302C is not enough, and thus the 2 GB resource allocation may need to be increased. It is worth noting that the increase should be in line with what resources a (new) node in the cluster has to offer. For example, if it is a 64 GB node, the limits should not exceed the allocatable storage that the node has to offer.

The divisions between the stateful sets may be based on the median resource utilization for all instances. More specifically, in the case of a small, medium, and large stateful set, the division between the small and the medium stateful sets may be set at 50% of the median resource utilization for all instances. Likewise, the division between the medium and the large stateful sets may be set at 200% of the median resource utilization for all instances.

In some example embodiments, this division may be scaled differently under different environments. Thus, for example, one computing environment will have the division between the small and the medium stateful sets may be set at 50% of the median resource utilization for all instances and the division between the medium and the large stateful sets may be set at 200% of the median resource utilization for all instances (essentially 1× scaling of the above numbers), while for a different computing environment the division between the small and the medium stateful sets may be set at 25% of the median resource utilization for all instances and the division between the medium and the large stateful sets may be set at 400% of the median resource utilization for all instances (essentially 2× scaling of the above numbers).

Other mechanisms for determining divisions between stateful sets are possible as well.

During runtime, Kafka message broker(s) 322 may get polled by the various instances 304A, 304B, . . . , 304N, 306A, 306B, . . . , 306N, 308A, 308B, . . . , 308N to identify events posted to topics that various corresponding event consumers have subscribed to. These events may be stored in event database 324.

The actual resources being allocated by the Statefulsets may be controlled by the events, and specifically by the application controlling the corresponding Statefulsets as indicated by the events.

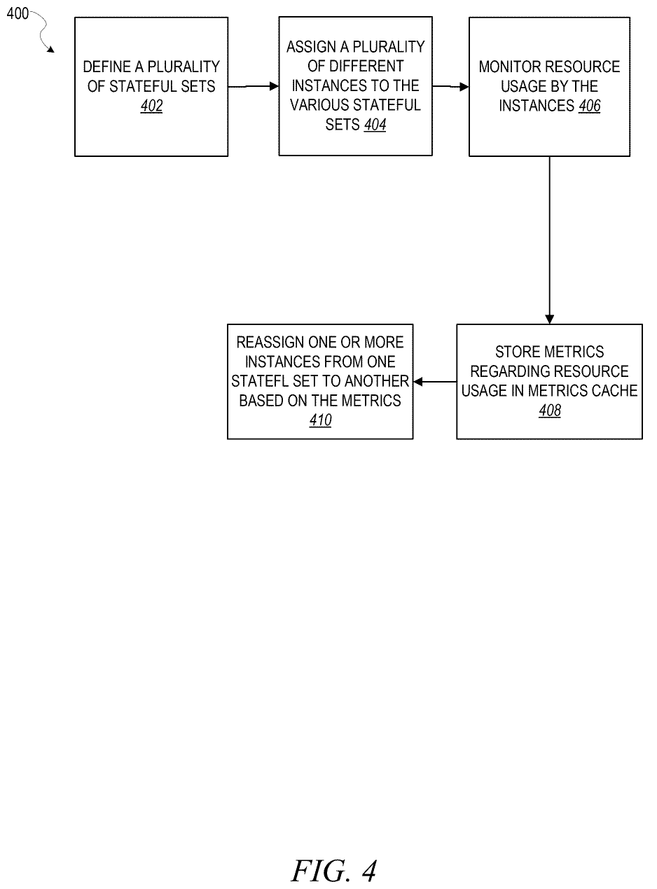

FIG. 4 is a flow diagram illustrating a method 400 for assigning instances in a container-orchestration system, in accordance with an example embodiment. At operation 402, a plurality of different stateful sets is defined. Each different stateful set is defined with a different resource allocation level. Here resource allocation level means some combination of resources at some particular level or combination of levels. For example, the resource allocation level may indicate a particular storage size, or a particular number of CPU threads, or some combination of both.

At operation 404, a plurality of different instances can be assigned to the various stateful sets. Initially, this may be based on some sort of expected resource utilization level for each instance. Alternatively, the instances may initially be assigned to the stateful set with the highest resource allocation level and it may be assumed that the subsequent operations will reassign appropriate resources to their appropriate corresponding stateful set based on actual resource utilization.

At operation 406, resource usage by the instances is monitored.

At operation 408, metrics regarding resource usage are stored in a metrics cache.

At operation 410, based on the metrics, one or more instances are reassigned from one stateful set to another stateful set.

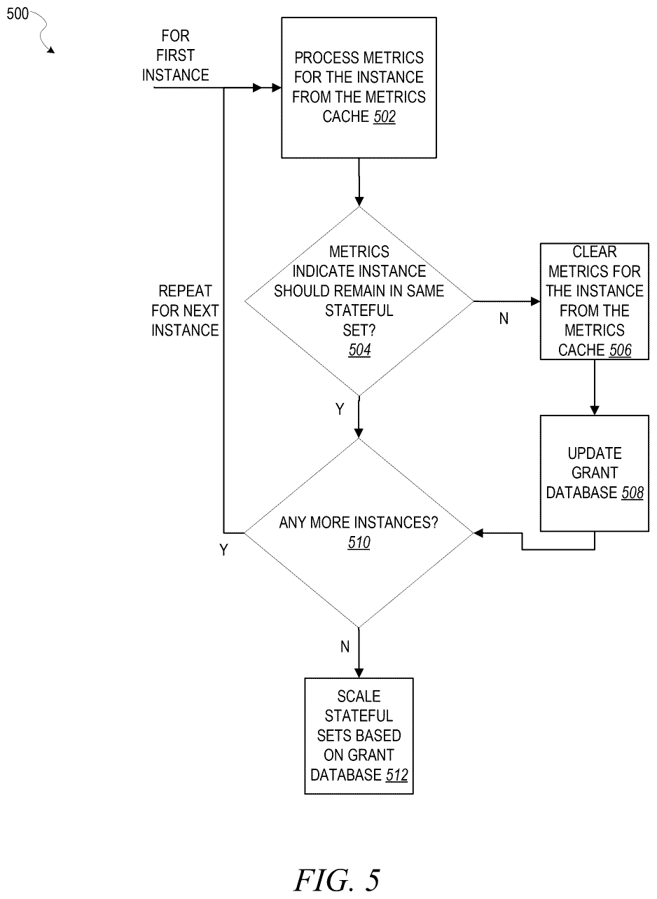

FIG. 5 is a flow diagram illustrating a method 500 for clearing a metrics cache, in accordance with an example embodiment. The method 500 includes a loop for each of a plurality of instances. Beginning with a first instance, at operation 502 metrics for the instance from the metrics cache are processed. Then at operation 504 it is determined if the metrics for the instance that the instance should remain assigned to the same stateful set as it currently is. If not, then at operation 506, the metrics for the instance are cleared from the metrics cache and at operation 508 a grant database is updated to reflect the need to reassign the instance to a different stateful set. Then, or if it was determined at operation 504 that the metrics indicate that the instance should remain assigned to the same stateful set as it currently is, at operation 510 it is determined whether there are any more instances. If so, then the method 500 loops back to operation 502 for the next instance. If not, then at operation 512 the stateful sets are scaled based on the reassignments described in the grant database.

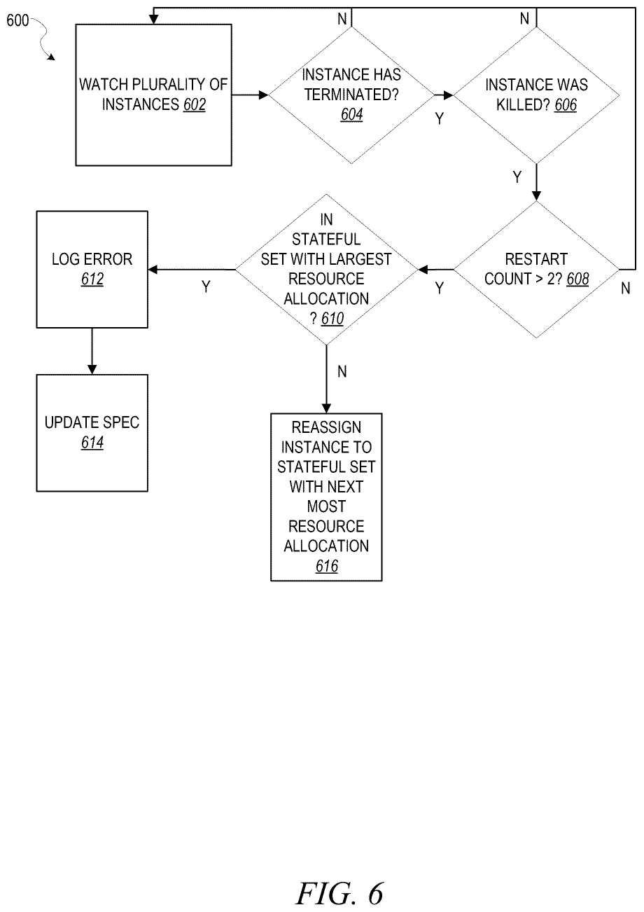

FIG. 6 is a flow diagram illustrating a method 600 for metrics cache handling and recovery, in accordance with an example embodiment. At operation 602, a plurality of instances are watched. At operation 604, it is determined whether an instance has terminated. If not, then the method 600 loops back to operation 602 to continue to watch the plurality of instances. If so, then at operation 606 it is determined if the reason the instance has terminated is that it was killed. If not, then the method 600 loops back to operation 602 to continue to watch the plurality of instances. If so, however, then at operation 608 it is determined whether the restart count is greater than 2. This means that the instance has been attempted to be restarted more than twice. If not, then the method 600 loops back to operation 602 to continue to watch the plurality of instances. If so, however, then at operation 610 it is determined whether the stateful set to which the instance is the stateful set with the largest resource allocation. If so, when at operation 612 an error can be logged indicating that the instance has exceeded its assigned resources. Then at operation 614, the spec for the stateful set to which the instance is assigned is updated to increase the assigned resources.

If it is determined at operation 610 that the stateful set to which the instance is not the stateful set with the largest resource allocation, then at operation 616 the instance is reassigned to the stateful set with the next most assigned resources. This is accomplished by deleting the instance from its current stateful set and starting a new instance in the stateful set with the next most assigned resource.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: defining a first stateful set in a container-orchestration system as having a first resource allocation level; defining a second stateful set in the container-orchestration system as having a second resource allocation level; assigning instances to the first and second stateful sets based on expected resource usage of the instances, the assigning causing each instance assigned to the first stateful set to be allocated resources in accordance with the first resource allocation level and each instance assigned to the first stateful set to be allocated resources in accordance with the second resource allocation level; monitoring resource usage by the instances; based on the monitored resource usage, determining that a first instance assigned to the first stateful set is utilizing resources within a threshold of the first resource allocation level; and based on the determination, causing the first instance to be reassigned from the first stateful set to the second stateful set. In Example 2, the subject matter of Example 1 comprises, wherein the monitoring comprises periodically querying a metrics application program interface (API) for metric information and storing the metric information in a metrics cache.

In Example 3, the subject matter of Example 2 comprises, wherein the operations further comprise: deleting metric information for the first instance from the metrics cache.

In Example 4, the subject matter of Examples 1-3 comprises, wherein the causing the first instance to be reassigned comprises requesting that an auto-scaler reduce a number of instances assigned to the first stateful set by one and increase a number of instances assigned to the second stateful set by two.

In Example 5, the subject matter of Examples 1-4 comprises, wherein the operations further comprise redefining the first resource allocation level and the second resource allocation level based on the monitored resource usage.

In Example 6, the subject matter of Examples 1-5 comprises, wherein each instance is an event consumer that consumes events from a message broker.

In Example 7, the subject matter of Examples 1-6 comprises, wherein the resources comprise storage space.

In Example 8, the subject matter of Examples 1-7 comprises, wherein the resources comprise central processing unit (CPU) threads.

Example 9 is a method comprising: defining a first stateful set in a container-orchestration system as having a first resource allocation level; defining a second stateful set in the container-orchestration system as having a second resource allocation level; assigning instances to the first and second stateful sets based on expected resource usage of the instances, the assigning causing each instance assigned to the first stateful set to be allocated resources in accordance with the first resource allocation level and each instance assigned to the first stateful set to be allocated resources in accordance with the second resource allocation level; monitoring resource usage by the instances; based on the monitored resource usage, determining that a first instance assigned to the first stateful set is utilizing resources within a threshold of the first resource allocation level; and based on the determination, causing the first instance to be reassigned from the first stateful set to the second stateful set.

In Example 10, the subject matter of Example 9 comprises, wherein the monitoring comprises periodically querying a metrics application program interface (API) for metric information and storing the metric information in a metrics cache.

In Example 11, the subject matter of Example 10 comprises, deleting metric information for the first instance from the metrics cache.

In Example 12, the subject matter of Examples 9-11 comprises, wherein the causing the first instance to be reassigned comprises requesting that an auto-scaler reduce a number of instances assigned to the first stateful set by one and increase a number of instances assigned to the second stateful set by two.

In Example 13, the subject matter of Examples 9-12 comprises, redefining the first resource allocation level, and the second resource allocation level based on the monitored resource usage.

In Example 14, the subject matter of Examples 9-13 comprises, wherein each instance is an event consumer that consumes events from a message broker.

In Example 15, the subject matter of Examples 9-14 comprises, wherein the resources comprise storage space.

In Example 16, the subject matter of Examples 9-15 comprises, wherein the resources comprise central processing unit (CPU) threads.

Example 17 is a non-transitory machine-readable medium storing instructions which, when executed by one or more processors, cause the one or more processors to perform operations comprising: defining a first stateful set in a container-orchestration system as having a first resource allocation level; defining a second stateful set in the container-orchestration system as having a second resource allocation level; assigning instances to the first and second stateful sets based on expected resource usage of the instances, the assigning causing each instance assigned to the first stateful set to be allocated resources in accordance with the first resource allocation level and each instance assigned to the first stateful set to be allocated resources in accordance with the second resource allocation level; monitoring resource usage by the instances; based on the monitored resource usage, determining that a first instance assigned to the first stateful set is utilizing resources within a threshold of the first resource allocation level; and based on the determination, causing the first instance to be reassigned from the first stateful set to the second stateful set. In Example 18, the subject matter of Example 17 comprises, wherein the monitoring comprises periodically querying a metrics application program interface (API) for metric information and storing the metric information in a metrics cache.

In Example 19, the subject matter of Example 18 comprises, wherein the operations further comprise: deleting metric information for the first instance from the metrics cache.

In Example 20, the subject matter of Examples 17-19 comprises, wherein the causing the first instance to be reassigned comprises requesting that an auto-scaler reduce a number of instances assigned to the first stateful set by one and increase a number of instances assigned to the second stateful set by two.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

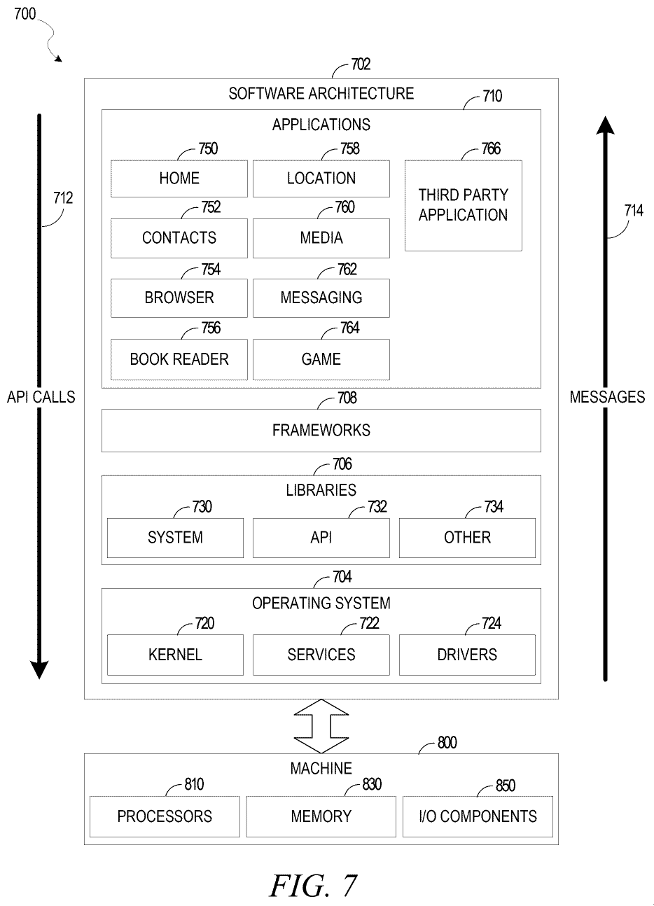

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke Application Program Interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphical user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the methods of FIGS. 5 and 6. Additionally, or alternatively, the instructions 816 may implement FIGS. 1-6 and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor 812), multiple processors 812, 814 with a single core, multiple processors 812, 814 with multiple cores, or any combination thereof.

The memory 830 may include a main memory 832, a static memory 834, and a storage unit 836, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., coupled via a USB).

Moreover, the communication components 864 may detect identifiers or include components operable to detect identifiers. For example, the communication components 864 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (i.e., 830, 832, 834, and/or memory of the processor(s) 810), machine-readable medium 838 and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., Hypertext Transfer Protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
defining a first stateful set in a container-orchestration system as having a first resource allocation level;
defining a second stateful set in the container-orchestration system as having a second resource allocation level;
assigning instances to the first and second stateful sets based on expected resource usage of the instances, the assigning causing each instance assigned to the first stateful set to be allocated resources in accordance with the first resource allocation level and each instance assigned to the first stateful set to be allocated resources in accordance with the second resource allocation level;
monitoring resource usage by the instances;
based on the monitored resource usage, determining that a first instance assigned to the first stateful set is utilizing resources within a threshold of the first resource allocation level; and
based on the determination, causing the first instance to be reassigned from the first stateful set to the second stateful set.

2. The system of claim 1, wherein the monitoring comprises periodically querying a metrics application program interface (API) for metric information and storing the metric information in a metrics cache.

3. The system of claim 2, wherein the operations further comprise:
deleting metric information for the first instance from the metrics cache.

4. The system of claim 1, wherein the causing the first instance to be reassigned comprises requesting that an auto-scaler reduce a number of instances assigned to the first stateful set by one and increase a number of instances assigned to the second stateful set by two.

5. The system of claim 1, wherein the operations further comprise redefining the first resource allocation level and the second resource allocation level based on the monitored resource usage.

6. The system of claim 1, wherein each instance is an event consumer that consumes events from a message broker.

7. The system of claim 1, wherein the resources comprise storage space.

8. The system of claim 1, wherein the resources comprise central processing unit (CPU) threads.

9. A method comprising:
defining a first stateful set in a container-orchestration system as having a first resource allocation level;
defining a second stateful set in the container-orchestration system as having a second resource allocation level;
assigning instances to the first and second stateful sets based on expected resource usage of the instances, the assigning causing each instance assigned to the first stateful set to be allocated resources in accordance with the first resource allocation level and each instance assigned to the first stateful set to be allocated resources in accordance with the second resource allocation level;
monitoring resource usage by the instances;
based on the monitored resource usage, determining that a first instance assigned to the first stateful set is utilizing resources within a threshold of the first resource allocation level; and
based on the determination, causing the first instance to be reassigned from the first stateful set to the second stateful set.

10. The method of claim 9, wherein the monitoring comprises periodically querying a metrics application program interface (API) for metric information and storing the metric information in a metrics cache.

11. The method of claim 10, further comprising:
deleting metric information for the first instance from the metrics cache.

12. The method of claim 9, wherein the causing the first instance to be reassigned comprises requesting that an auto-scaler reduce a number of instances assigned to the first stateful set by one and increase a number of instances assigned to the second stateful set by two.

13. The method of claim 9, further comprising redefining the first resource allocation level and the second resource allocation level based on the monitored resource usage.

14. The method of claim 9, wherein each instance is an event consumer that consumes events from a message broker.

15. The method of claim 9, wherein the resources comprise storage space.

16. The method of claim 9, wherein the resources comprise central processing unit (CPU) threads.

17. A non-transitory machine-readable medium storing instructions which, when executed by one or more processors, cause the one or more processors to perform operations comprising:
defining a first stateful set in a container-orchestration system as having a first resource allocation level;
defining a second stateful set in the container-orchestration system as having a second resource allocation level;
assigning instances to the first and second stateful sets based on expected resource usage of the instances, the assigning causing each instance assigned to the first stateful set to be allocated resources in accordance with the first resource allocation level and each instance assigned to the first stateful set to be allocated resources in accordance with the second resource allocation level;
monitoring resource usage by the instances;
based on the monitored resource usage, determining that a first instance assigned to the first stateful set is utilizing resources within a threshold of the first resource allocation level; and
based on the determination, causing the first instance to be reassigned from the first stateful set to the second stateful set.

18. The non-transitory machine-readable medium of claim 17, wherein the monitoring comprises periodically querying a metrics application program interface (API) for metric information and storing the metric information in a metrics cache.

19. The non-transitory machine-readable medium of claim 18, wherein the operations further comprise:
deleting metric information for the first instance from the metrics cache.

20. The non-transitory machine-readable medium of claim 17, wherein the causing the first instance to be reassigned comprises requesting that an auto-scaler reduce a number of instances assigned to the first stateful set by one and increase a number of instances assigned to the second stateful set by two.
